(19) United States
(12) Patent Application Publication
(10) Pub. No.: US 2012/0285882 A1
(43) Pub. Date: Nov. 15, 2012

(54) MEMBRANE AND METHOD FOR PRODUCING THE SAME

(76) Inventors: May May TEOH, Singapore (SG); Na PENG, Singapore (SG); Tai-Shung CHUNG, Singapore (SG)

(21) Appl. No.: 13/104,562

(22) Filed: May 10, 2011

(51) Int. Cl. B01D 71/06; B01D 71/34; B01D 71/36; B01D 71/40; B01D 67/00; D01D 5/06; B01D 69/00; B01D 71/68; B82Y 40/00

(52) U.S. Cl. 210/500.22; 264/48; 425/70; 977/781

(57) ABSTRACT

The present disclosure relates to a membrane comprising a porous polymer body with a plurality of channels extending through the polymer body, a method of producing the same and a water treatment system comprising the membrane.

### TECHNICAL FIELD

The present invention generally relates to a novel membrane and a method of fabricating the membrane.

### BACKGROUND

Membrane distillation is an emerging technology for seawater desalination. Membrane distillation differs from known distillation techniques such as multi-stage flash, multiple effect distillation and vapour compression in that a non-selective, porous membrane is used. This membrane forms a separation between the warm vaporizing retentate stream and the condensed stream, the distillate stream.

Hollow fiber membranes (i.e., hollow fiber modules) and flat sheet asymmetric membranes (i.e., spiral wound modules) are two dominant membrane configurations used in water treatment and membrane distillation processes. Compared with flat sheet membranes, hollow fiber membranes have a high membrane area per volume ratio and may be easily assembled into the membrane module. However, hollow fibers have several major drawbacks. These drawbacks include low mechanical strength and the possibility of deformation or rupture after prolonged use in industrial applications. In addition, hollow fibers may entangle and twist with adjacent fibers and are intolerant for back washing and chemical cleaning.

One of the reasons that most commercially available hydrophobic flat-sheet and hollow fiber membranes utilized in membrane distillation may not be readily used for membrane distillation processes is because they are originally manufactured and designed for other applications, such as microfiltration or ultra-filtration.

With respect to the production of hollow fiber membranes, melt spinning and solution spinning processes have been used to manufacture such membranes. However, both processes may develop spinning instabilities in longitudinal and transversal directions that lead to fiber break-up during production or defective products with non-uniform wall thickness, deformed cross-section, and grooved inner surfaces.

Microporous membranes are particularly suitable for use in membrane distillation and they are prepared by phase inversion, wherein a polymer is dissolved in an appropriate solvent and a suitable viscosity of the solution is achieved. The polymer solution may then be made into a film or a hollow fiber, and then immersed in a precipitation bath. This causes separation of the homogeneous polymer solution into a solid polymer and liquid solvent phase. The precipitated polymer forms a porous structure containing a network of pores.

However, such a process exhibits unevenness in phase separation in the thickness direction that causes the formation of a membrane having an asymmetric structure containing macrovoids, which in turn reduces the mechanical strength of the membrane. Furthermore, there are many production parameters on which the structure and the properties of the membrane depend. The melt extraction process yields a relatively uniform, high-strength membrane with no macrovoids. However, despite its advantages, melt spinning is associated with a number of potential limitations or drawbacks. This process may be limited to certain choices of polymer materials or materials that can be melted within a certain temperature range. Melt spinning may only be used to produce very fine, thin fibers, and may not be effective for making thicker threads. Accordingly, there is a need to provide a membrane that overcomes, or at least ameliorates, the disadvantages mentioned above.

### SUMMARY

In a first aspect, there is provided a membrane comprising a porous polymer body with a plurality of channels extending through said polymer body. In one embodiment, the membrane is a unitary body and the plurality of channels extends through the unitary body. In another embodiment, the channels are disposed adjacent to each other, wherein each channel shares at least one common wall with an adjacent channel. Advantageously, the disclosed membrane combines the technical advantages of both a flat sheet membrane and a hollow fiber membrane. In particular, the disclosed membrane demonstrates greater mechanical durability relative to conventional hollow fiber membranes. Also advantageously, the structural configuration of the disclosed membrane may allow it to be easily assembled into membrane modules for retrofitting into water treatment systems and the like.

In a second aspect, there is provided a fluid treatment system comprising:

a porous membrane body comprising an exterior surface and a plurality of channels extending through said body, opposite said exterior surface;

a feed fluid having one or more impurities contained therein and being passed through at least one of (i) the exterior surface of said porous membrane body or (ii) the walls of said plurality of channels, wherein after passage through either said exterior surface or said walls of said channels, a permeate fluid is formed on the opposite side from which the feed fluid passed, said permeate stream having less impurities relative to said feed water.

In one embodiment, the feed fluid is pure water. In another embodiment, the feed water is saline water and the impurities are salt. In yet another embodiment, the feed water contains impurities that are not fit for human or animal consumption.

In another embodiment, the fluid treatment system comprises plural porous membrane bodies with respective feed fluid streams and respective permeate streams, wherein in one embodiment the plural porous membranes are connected in series fluid flow wherein the porous stream of one porous membrane body is the feed stream of an adjacent downstream porous membrane body. In one embodiment where the feed fluid is water, the plural series fluid flow connected membrane bodies produce a permeate water stream that is potable in that it is capable of being consumed by humans and animals.

In a third aspect, there is provided a method of making a membrane comprising the step of forming a plurality of channels in a porous polymer body. In one embodiment, the forming step may comprise extruding a polymer solution into a coagulant bath. During said extruding step, the polymer solution may be extruded into the coagulant bath concurrently with one or more bore fluid streams passing therebetween said polymer solution to thereby form the porous membrane body. Advantageously, in one embodiment, the disclosed method may produce a membrane in the form of a porous polymer body having a plurality of channels extending through the body. In one embodiment, the plurality of channels may be disposed adjacent to each other, wherein each channel has a longitudinal axis that is substantially parallel to a longitudinal axis of an adjacent channel. Advantageously, the membrane produced in accordance with the disclosed method may contain all of the technical benefits of a membrane disclosed in the first aspect.

In a fourth aspect, there is provided a spinneret, for forming a polymer membrane comprising:

a chamber for containing a polymer solution therein and having an inlet for receiving said polymer solution; and

a polymer ejection nozzle in fluid communication with the chamber;

a series of bore fluid ejection nozzles for containing a bore fluid therein, the bore fluid ejection nozzles being disposed within the annulus of the polymer ejection nozzle such that when said polymer solution is ejected from the polymer ejection nozzle into a coagulant bath, the bore fluid is concurrently ejected from the bore fluid ejection nozzles to form a plurality of channels that extend through a porous polymer body. In one embodiment, the bore fluid may be a polar fluid, such as a fluid comprising water in admixture with a solvent.

Advantageously, the bore fluid ejection nozzles are disposed adjacent to each other so that the adjacently discharged bore fluid streams form a series of channels disposed along the porous polymer body formed during the extruding step. In one embodiment, when the polymer solution contacts the coagulant bath, the polymer solution solidifies and forms the porous polymer body whereas the plural bore fluid streams form the plurality of channels extending through said polymer body.

In one embodiment, the outer walls of the bore fluid ejection nozzles are disposed adjacent from each other at a distance of about 0.5 mm.

### DEFINITIONS

The following words and terms used herein shall have the meaning indicated:

The term “turbulent flow” as used in the context of the present specification is taken to refer to a state of a fluid flow that is characterized by a Reynolds Number of at least 4,000 or greater.

The term “hydrophobic” as used in the context of the present specification, is taken to refer to a non-wettable membrane surface that has substantially zero affinity to water molecules, such that the membrane does not allow passage of water through its surface to the other side of the membrane but may permit the passage of water vapour.

The term “equivalent diameter”, when used to describe the diameter dimension of a channel extending through the disclosed membrane, is taken to refer to the diameter of an imaginary circle, which has a circumference/surface area identical to the surface area/circumference of the channel in question.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### Disclosure of Optional Embodiments

Exemplary, non-limiting embodiments of the porous membrane body will now be disclosed.

The disclosed membrane may comprise plural channels, wherein the longitudinal axis of each channel is parallel to the longitudinal axis of an adjacent channel. Advantageously, the parallel configuration of the channels may serve to reinforce the structural strength of the membrane and allow the membrane to better handle high feed fluid flow rates. In one embodiment, each channel may have an inlet at one end and an outlet at an opposite end to the inlet. The channels may be configured to receive a feed fluid flow from which a permeate stream may form on the other side of the membrane (the shell side). Conversely, the channels may be configured to transmit a permeate flow when feed fluid is passed over the shell side of the membrane.

The disclosed membrane may have an external surface that is uneven. In one embodiment, the uneven external surface of the membrane may comprise plural groove formations. In yet another embodiment, the groove formations are formed on at least a portion of the exterior surface of the membrane body. In another embodiment, the groove formations may be formed on substantially the entire surface of the exterior surface. In another embodiment, the groove formations may be formed on the interior surface of the channels extending through the membrane.

It has been postulated that the groove formations may be formed due to the hydrodynamic instability during the fabrication process of the polymer. The groove formations may also be formed during solidification-induced shrinkage of the polymer body which results in deformation of the membrane surface. Advantageously, the groove formations may promote eddy currents at the surface of the membrane when fluid flow passes thereover. As a result, fluid flow near the surface of the membrane may be substantially turbulent. Advantageously, the creation of turbulent flow conditions near or at the surface of the membrane results in an improved flux of permeate through the membrane and additionally, may reduce the incidence of fouling on the membrane surface.

The disclosed membrane may be used as a spacer in conjunction with one or more other discrete membranes in a membrane module. In one embodiment, the disclosed membrane may prevent discrete membranes disposed within a membrane module from attaching to one another.

The membrane sheet may assume a substantially rectangular shape. It has been surprisingly found that when the membrane sheet is in a substantially rectangular shape, there is greater flux enhancement when the linear flow velocity of feed water contacting the exterior surface of the membrane sheet is increased, as compared to conventional hollow fiber membranes. It has been postulated that the substantially rectangular shape of the membrane sheet may further promote the formation of eddy currents at the membrane surface and thereby result in turbulent flow conditions as noted above.

The plurality of channels may have cross-sectional shapes selected from the group consisting of circular-shaped, oval-shaped, square-shaped, spherical-shaped, rectangular-shaped, elliptically-shaped and combinations thereof. The cross-section of the channels may also be substantially amorphous in shape. In one embodiment, the cross-sectional shape of the channel is advantageously selected to uniformly distribute the pressure of the fluid flowing therein. This may minimize physical stress on the membrane and prevent deformation or collapse of the channel when is use. In one embodiment, the channels have a substantially spherical cross-sectional shape.

The porous polymer body of the membrane may be hydrophobic. Advantageously, in one embodiment, the hydrophobicity of the membrane prevents the mixing of permeate flowing in the plural channels of the membrane with the feed fluid that is flowing on the shell side of the membrane or vice versa.

The disclosed membrane may comprises a hydrophobic polymer selected from the group consisting of poly alkylacrylate, polydiene, polyolefin, polylactone, polysiloxane, polyoxirane, polypyridine, polycarbonate, poly vinyl acetate, polysulfone, polypropylene (PP), polytetrafluoroethylene (PTFE), polyethylene (PE), polyvinylidenefluoride (PVDF), polymethylpentene (PMP), polydimethylsiloxane, polybutadiene, polystyrene, polymethylmethacrylate, perfluoropolymer, poly (2-alkyl or in phenyl oxazolines), polyetheretherketone (PEEK), polyphenylene sulfide (PPS), liquid crystal polymers (LCPs), polyimides and copolymers thereof. In one embodiment, the hydrophobic polymer used for producing the membrane is PVDF. In another embodiment, the polymer may be a thermally conductive polymer.

The channels of the disclosed membrane may have a diameter or an equivalent diameter in the millimeter or micrometer range. In one embodiment, the channels of the disclosed membrane may have a diameter or an equivalent diameter of the channel of from about 450 μm to about 1500 μm, from about 500 μm to about 1400 μm, from about 600 μm to about 1300 μm, from about 700 μm to about 1200 μm, from about 800 μm to about 1100 μm and from about 900 μm to about 1000 μm. In one embodiment, the channels of the disclosed membrane may have a diameter or an equivalent diameter of about 1000 μm.

The disclosed membrane may have from 2 to 50 channels extending through the porous polymer body. In one embodiment, there are at least two channels extending through the polymer body. In one embodiment, there are at least seven channels extending through the polymer body. It will be appreciated that the number of channels may be selected in accordance with various operational factors, including but not limited to, the size of the membrane module, the desired throughput of permeate, and the flow rate of feed water the membrane is designed to handle. Therefore, it will be apparent to a skilled person that the actual disclosed number of channels is not limiting to the scope of the present invention.

The wall thickness between each adjacent channel may be in a micrometer range. In one embodiment, the wall thickness may be from about 10 μm to 120 μm. In one embodiment, the wall thickness may be from about 20 μm to about 70 μm.

The channels of the disclosed membrane may have longitudinal axes that are arranged in a single plane that extends through the membrane. Advantageously, arranging the channels on a single plane confers mechanical strength and structural stability. In another embodiment, the channels of the disclosed membrane may be arranged in a circular manner. In yet another embodiment, the channels may be concentrically arranged.

The disclosed membrane may provide a flux of from about 40 kgm⁻²hr⁻¹ to about 55 kgm⁻²hr⁻¹, when the feed fluid is heated to about 80° C. In one embodiment, the disclosed membrane may provide a flux of at least about 50 kgm⁻²hr⁻¹ when the feed fluid is at a temperature of about 80° C.

The disclosed membrane may have a porosity of at least 89% or more. In one embodiment, the disclosed membrane may have a porosity of from about 89% to about 91%. The pore size of the disclosed membrane may be from about 10 nm to about 1000 nm, from about 100 nm to about 900 nm, from about 200 nm to about 800 nm, from about 300 nm to about 700 nm and from about 400 nm to about 600 nm.

Exemplary, non-limiting embodiments of the method for making a membrane according to the third aspect above will now be disclosed.

The porous membrane body may be formed by extruding a polymer solution into a coagulant bath.

In one embodiment, during said extruding step, the polymer solution may be extruded into the coagulant bath concurrently with one or more bore fluid streams passing therebetween said polymer solution to thereby form said porous membrane body. In another embodiment, the extruding step may comprise passing the polymer solution through an outlet of a spinneret having a plurality of bore fluid ejection nozzles disposed therein, wherein the plurality of bore fluid ejection nozzles are configured to concurrently discharge plural streams of a bore fluid. In one embodiment, the bore fluid may be a polar fluid, such as water in admixture with a solvent. Prior to the extruding step, the polymer solution may be mixed with one or more additive compounds, at least one solvent compound and at least one non-solvent compound to form a doped-polymer solution.

The polymer solution may comprise at least one polymer selected from the group consisting of: poly alkylacrylate, polydiene, polyolefin, polylactone, polysiloxane, polyoxirane, polypyridine, polycarbonate, poly vinyl acetate, polysulfone, polypropylene (PP), polytetrafluoroethylene (PTFE), polyethylene (PE), polyvinylidenefluoride (PVDF), polymethylpentene (PMP), polydimethylsiloxane, polybutadiene, polystyrene, polymethylmethacrylate, perfluoropolymer, poly (2-alkyl or phenyl oxazolines), polyetheretherketone (PEEK), polyphenylene sulfide (PPS), liquid crystal polymers (LCPs), polyimides and copolymers thereof.

In one embodiment, the additive compound is a hydrophobic compound. Exemplary additive compounds may be selected from the group consisting of: polyolefins, silicates and silicate hydroxides of sodium, calcium, aluminium, and magnesium, clay, clay modified with alkylammonium salts, montmorillonite, rectangular carbon materials, and combinations thereof. In one embodiment, the additive is montmorillonite that has been modified with a dimethyl, dehydrogenated tallow quaternary ammonium salt, which is available commercially as Cloisute® clay 20A. In another embodiment, the additive may be polytetrafluoroethylene. Advantageously, the additive may be selected to reinforce the mechanical strength of the membrane. Further advantageously, the introduction of the additive into the polymer solution may also enhance the overall hydrophobicity of a membrane produced according to the disclosed method.

Exemplary solvent compounds that can be mixed with the polymer solution prior to the spinning step may be selected from the group consisting of: N-methyl-2-pyrrolidinone, dimethylacetamide, dimethylformamide, triethelyne phosphate, acetone, tetrehydrofuran, dioxane, ethyl acetate, propylene carbonate, methyl ethyl ketone, dimethyl sulfoxide, cyclohexane, methyl isobutyl ketone and dimethyl phthalate. In one embodiment, the solvent is N-methyl-2-lpyrrolidinone. In addition, exemplary non-solvent compounds for mixing with the polymer solution prior to the extruding step may be selected from the group comprising methanol, ethanol, propanol, butanols, diethylene glycol, ethylene glycol, glycerol, polyethylene glycol, polyvinylpyrrolidone and their mixtures thereof. Advantageously, the non-solvent compound that is added to the polymer solution to form a doped polymer solution aids in pore formation during the extruding step. In a preferred embodiment, ethylene glycol is used as the non-solvent compound.

In one embodiment, the bore fluid ejected from the bore fluid ejection nozzle may be a polar fluid. The polar fluid may comprise a solvent and water or mixtures thereof. In one embodiment, the solvent used in the polar fluid may be the same solvent used in preparing the doped-polymer solution. In another embodiment, another solvent selected from the above disclosed list may be used.

During the step of extruding the doped-polymer solution into the coagulant bath in conjunction with the polar fluid, the ratio of flow rates between the doped-polymer solution and the polar fluid may be in a range of from about 0.8 to about 2.0, from about 0.8 to about 1.8, from about 0.8 to about 1.6, from about 0.8 to about 1.5, from about 0.8 to about 1.2, from 0.8 to about 1.0. In one embodiment, the ratio of the flow rate between the doped-polymer solution and the polar fluid is from about 0.8 to about 1.50. The ratio of the doped polymer solution to the polar fluid may be suitably adjusted in order to obtain a membrane having a desired cross-sectional shape of the channels. In one embodiment, the ratio of doped polymer solution to the polar fluid is approximately 1.0.

The porous polymer body that is obtained from the extruding step may be subjected to further post-treatment in a water bath. In one embodiment, the porous polymer body may be submerged into water at room temperature for approximately three days to remove residual solvent and non-solvent compounds. The porous polymer body may thereafter be subjected to a freezing step wherein it is placed in freezer for at least two hours, followed by a freeze drying step which may be undertaken for about twelve hours. The resultant dried membranes may be suitable for membrane characterization and for use in module fabrication.

The disclosed method may further comprise a step of arranging the bore fluid ejection nozzles adjacent relative to one another and having a separation of from about 5.0 mm to 10 mm from one nozzle to another. Advantageously, the selection of nozzle separation may be selected to achieve a desired thickness of the wall separating one membrane channel from an adjacent membrane channel in the porous membrane body.

In the disclosed method, the medium used as the coagulant bath may be selected from the group consisting of methanol, ethanol, propanol, butanol, water and mixtures thereof. In a preferred embodiment, the coagulant bath is comprised substantially of water. Advantageously, water is readily available and has a high degree of polarity which renders it a cost-effective medium as well as strong non-solvent for use in fixing the shape of the porous polymer body.

Exemplary, non-limiting embodiments of the water treatment system according to the second aspect above will now be disclosed.

In one embodiment, the feed fluid may be preheated with a source of waste heat. In one embodiment, the feed fluid may be sea water.

The impurities in the feed fluid may be selected from chlorates, chlorides, carbonates, sulphates, bromides and fluorides of metal ions, such as calcium, potassium, sodium and magnesium. In one embodiment, the impurity is predominantly sodium chloride.

The permeate stream may contain lesser impurities than the feed fluid. In one embodiment, the permeate stream may contain substantially no impurities.

The permeate stream may also be used for direct industrial consumption. In another embodiment, the permeate stream may be used directly as potable water. In one embodiment, the quality of the permeate steam is substantially pure water, which does not need to go through a reverse osmosis (RO) unit or a membrane bioreactor (MBR) for direct use as potable water. In another embodiment, pretreatment of the feed fluid such as microfiltration (MF) or ultrafiltration (UF) may be implemented prior to passing through the membrane distillation to reduce membrane fouling.

Exemplary, non-limiting embodiments of the spinneret according to the fourth aspect above will now be disclosed.

The outlet may be configured to be movable when discharging the fluid mixture. In one embodiment, the outlet may be configured to be spun about a normal axis extending from the centre of the outlet. The plurality of nozzles may comprise a series of nozzles arranged adjacent to one and other. In one embodiment, the longitudinal axes of the nozzles may be arranged on a single plane such that they are substantially parallel to one another. In one embodiment, the spinneret may comprise at least seven nozzles arranged in the above disclosed manner.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 shows a schematic diagram of the fabrication process of a membrane.

FIG. 2(a) shows a schematic diagram of the side view of a multi-channel spinneret.

FIG. 2(b) is a picture taken showing the front view of the spinneret of FIG. 2(a).

FIG. 3 shows a cross-sectional view of the outlet of the spinneret when viewed from the bottom.

FIG. 4(a) shows a microscope image of a cross-sectional view of a multi-channel rectangular membrane obtained with a doped-polymer solution:bore fluid flow ratio of 6:4.

FIG. 4(b) shows a microscope image of a cross-sectional view of a multi-channel rectangular membrane obtained with a doped-polymer solution:bore fluid flow ratio of 8:6.

FIG. 4(c) shows a microscope image of a cross-sectional view of a multi-channel rectangular membrane obtained with a doped-polymer solution:bore fluid flow ratio of 10:8.

FIG. 4(d) shows a microscope image of a cross-sectional view of a multi-channel rectangular membrane obtained with a doped-polymer solution:bore fluid flow ratio of 8:8.

FIG. 4(e) shows a microscope image of a cross-sectional view of a multi-channel rectangular membrane obtained with a doped-polymer solution:bore fluid flow ratio of 8:10.

FIG. 4(f) shows a microscope image of a cross-sectional view of a hollow fiber membrane obtained with a doped-polymer solution:bore fluid flow ratio of 2:2.

FIG. 5 is a schematic diagram showing the steps involved in a proposed mechanism of grooved outer layer deformation.

FIG. 6(a) shows a cross-sectional view and the shape of the inner contour of one of the channels of a multi-channel rectangular membrane with a bore fluid flow rate of 6 ml min⁻¹.

FIG. 6(b) shows a cross-sectional view and the shape of the inner contour of one of the channels of a multi-channel rectangular membrane with a bore fluid flow rate of 8 ml min⁻¹.

FIG. 6(c) shows a cross-sectional view and the shape of the inner contour of one of the channels of a multi-channel rectangular membrane with a bore fluid flow rate of 10 ml min⁻¹.

FIG. 7(a) shows a Scanning Electron Microscope (SEM) image of the cross-section of a PVDF multi-channel rectangular membrane obtained at 50× magnification.

FIG. 7(b) shows a SEM image of the outer surface of the membrane of FIG. 7(a) obtained at 10,000× magnification.

FIG. 7(c) shows a SEM image of an enlarged cross sectional view of the membrane of FIG. 7(a) obtained at 1,000× magnification.

FIG. 7(d) shows a SEM image of the inner surface of the membrane of FIG. 7(a) obtained at 10,000× magnification.

FIG. 7(e) shows a SEM image of an enlarged view of the inner surface of the cross-section shown in FIG. 7(c) obtained at 5,000× magnification.

FIG. 7(f) shows a SEM image of an enlarged view of the middle layer of the cross-section shown in FIG. 7(c) obtained at 5,000× magnification.

FIG. 7(g) is a SEM image of an enlarged view of the outer surface of the cross-section shown in FIG. 7(c) obtained at 5,000× magnification.

FIG. 8(a) shows a SEM image of the cross-section of a conventional PVDF hollow fiber membrane obtained at 50× magnification.

FIG. 8(b) shows a SEM image of the outer surface of the membrane of FIG. 8(a) obtained at 5,000× magnification.

FIG. 8(c) shows a SEM image of the inner surface of the membrane of FIG. 8(a) obtained at 5,000× magnification.

FIG. 8(d) shows a SEM image of an enlarged cross sectional view of the membrane of FIG. 8(a) obtained at 700× magnification.

FIG. 8(e) shows a SEM image of an enlarged view of the inner surface of FIG. 8(d) obtained at 5,000× magnification.

FIG. 8(f) shows a SEM image of an enlarged view of the outer surface of FIG. 8(b) obtained at 5,000× magnification.

FIG. 9 is a graph showing the permeation flux obtained for three PVDF multi-channel rectangular membranes prepared according to the present disclosure with varying ratios of doped-polymer solution to bore fluid.

FIG. 10 is a graph showing the permeation flux obtained for three PVDF multi-channel rectangular membranes prepared according to the present disclosure with varying ratios of doped-polymer solution to bore fluid.

FIG. 11 is a graph showing the permeation flux obtained for conventional PVDF hollow fiber membranes prepared with varying flow rates of doped-polymer solution to bore fluid.

FIG. 12 (a) is a graph showing the relationship between flux and temperature of the feed solution fed to the multi-channel rectangular membrane, wherein the hot feed solution comprises 3.5 wt % NaCl and is at temperature of 60.1±0.2° C. and wherein a cold permeate stream having a temperature of about 17.2±0.2° C. is passed through the channel of the membrane at a velocity of 1.14±0.02 ms⁻¹.

FIG. 12 (b) is a graph showing the relationship between flux and the linear velocity of the cold permeate stream for a multi-channel rectangular membrane prepared according to the present disclosure and a conventional hollow fiber membrane. The cold permeate has a temperature of 17.2±0.3° C. and the feed solution has a temperature of 60.1±0.2° C., and comprises 3.5 wt % NaCl, having a flow rate of 1.15±0.03 ms⁻¹.

FIG. 13 shows the proposed transport mechanisms of water vapor through a multi-channel rectangular membrane and a typical hollow fiber membrane from the shell side to the tube side.

### DETAILED DESCRIPTION OF DRAWINGS

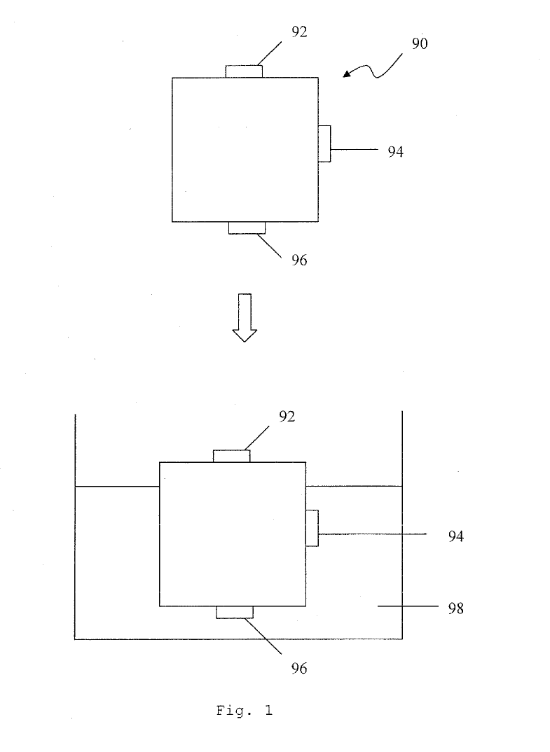

Referring to FIG. 1, there is shown a schematic diagram of the fabrication of a multichannel rectangular membrane of the present disclosure.

Firstly, a doped-polymer solution comprising of a polymer, a solvent and a non-solvent enters the spinneret 90 via an inlet 92. A mixture of solvent and water is employed as a bore fluid which enters the spinneret 90 via an inlet 94. The dope-polymer solution may be discharged through an outlet 96. A series of bore fluid ejection nozzles are provided within the annulus region of outlet 96 (not shown) as will be further described with reference to FIG. 3.

Next, a wet spinning step is undertaken where the outlet 96 is contacted with a coagulation bath 98 without air-gap. The medium used in the coagulant bath 98 is water. The doped-polymer solution and the bore fluid are passed out of outlet 96 and the bore fluid ejection nozzles residing therein respectively into the coagulant bath 98. As the polymer solution contacts the coagulant bath 98, it begins to solidify into a membrane having a porous membrane body. Concurrently, the flow of the bore fluid causes the formation of a plurality of channels extending through the porous membrane body.

The as-spun membranes (not shown) are subsequently removed from the coagulation bath 98 and submerged in tap water at room temperature to remove the residual solvent and non-solvent.

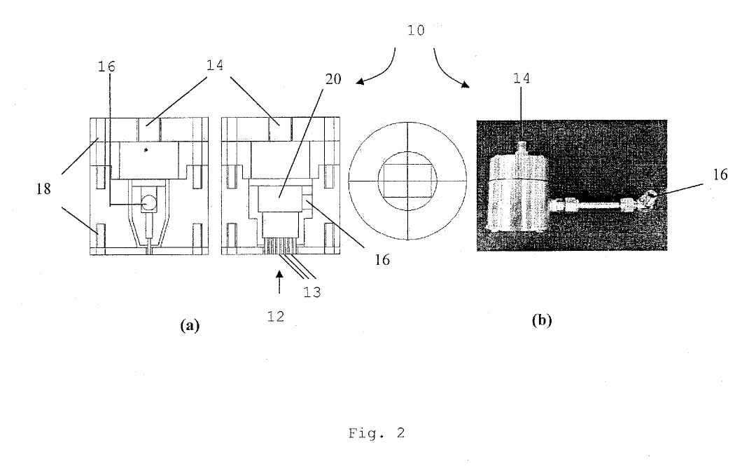

FIG. 2(a) shows a side view of a spinneret 10 for producing a multichannel rectangular membrane according to the present invention. The spinneret 10 comprises an inlet 14 for receiving the doped-polymer solution and an inlet 16 for receiving the bore fluid. The doped-polymer fluid is collected in a chamber 20 to ensure even distribution prior to extrusion from the spinneret. The spinneret 10 further comprises connectors 18 and an outlet 12. It can be seen that the outlet 12 of the spinneret 10 comprises a plurality of nozzles 13 disposed within the annulus of outlet 12. The nozzles 13 are in fluid communication with inlet 16 for receiving and discharging a bore fluid.

FIG. 2(b) shows a picture of the front view of the spinneret of FIG. 2(a).

Referring now to FIG. 3, there is shown a schematic diagram of the outlet of the spinneret shown in FIG. 2(a) when viewed from the bottom. An outlet in accordance with FIG. 2(a) comprising an array 100 of nozzles (a . . . g) is shown. The doped-polymer solution flows out of the spinneret through an outlet 120, while the bore fluid exits the spinneret through the nozzles (a . . . g). The nozzles (a . . . g) are disposed uniformly over the entire bottom surface of the outlet of the spinneret, whereby each nozzle is of a substantially similar diameter and being substantially equally spaced apart from a neighboring nozzle. The nozzles (a . . . g) are disposed substantially close to one another such that the doped-polymer solution exiting the outlet 120 is capable of forming a continuous unitary polymer body when contacted with a coagulant bath.

### EXAMPLES

Non-limiting examples of the invention and comparative examples will be further described in greater detail by reference to specific Examples, which should not be construed as in any way limiting the scope of the invention.

### Materials

Kureha polyvinylidene fluoride (PVDF) T#1300 resin (specific gravity 1.77) was supplied by Kureha Corporation, Japan. Organophilic clay, Cloisite clay 20A, a natural montmorillonite modified with a dimethyl, dehydrogenated tallow quaternary ammonium salt, was purchased from Southern Clay (Gonzales, Tex.). The solvent, N-methyl-2-pyrrolodinone (NMP, >99.5%), and non-solvent ethylene glycol (EG, >99.5%) were purchased from Merck, and Panreac, respectively. Sodium chloride (NaCl, 99.5%) was purchased from Merck and Milli-Q ultra-pure water was produced in laboratory with the resistivity of 18 MΩcm. All chemical were used as received.

### Example 1

### Polymer Dope Preparation and PVDF Rectangular Membrane and Rectangular Membrane Fabrication

Firstly, the PVDF and Cloisite clay 20A hydrophobic particles were dried overnight at 100±2° C. in a vacuum oven (2 mbar) to remove moisture content before use. The PVDF resin and Cloisite clay particles were added into the N-methyl-2-pyrrolodinone (NMP) and non-solvent ethylene glycol (EG) mixture and stirred to become a homogenous PVDF/NMP/Cloisite clay/EG doped-polymer solution. The doped-polymer solution was poured into syringe pumps and degassed before spinning process. A mixture of NMP/water 50/50 wt % was employed as the bore fluid. Next, the formulated doped-polymer solution and the bore fluid are fed into the spinneret.

The spinneret is then dipped into an external coagulant bath. Tap water was utilized as the external coagulant. Water was selected to induce an instantaneous precipitation and thus secure the shape of the membranes. Accordingly, the nascent membranes exiting the spinneret enter the external coagulant bath without air-gap (wet spinning) and additional drawing. The as-spun membranes are then submerged in tap water at room temperature for 3 days to remove the residual NMP and EG.

### Example 2

### Membrane Characterization

To prepare dry samples for characterizations and module fabrication, the wet membranes were frozen in a freezer for 2 hr, followed by freeze drying (˜12 hrs). The spinning conditions are tabulated in Table 1 below. For comparison, hollow fiber membranes HF-1 to HF-3 were also spun from similar conditions described hereinabove.

TABLE 1
Spinning parameters of PVDF multichannel
rectangular and hollow fiber membranes

| | Hollow rectangular | | | | | Hollow fiber | | |
|---|---|---|---|---|---|---|---|---|
| Membrane ID | A | B | B-1 | B-2 | C | HF-1 | HF-2 | HF-3 |
| Dope solution | PVDF Kureha 1300/NMP/Clay20A/EG 10/74.7/3.3/12 | | | | | | | |
| composition | | | | | | | | |
| Bore fluid | NMP/Water 50/50 wt % | | | | | | | |
| composition | | | | | | | | |
| Dope flow | 6 | 8 | | | 10 | 2 | | |
| rate (ml/min) | | | | | | | | |
| Bore fluid | 4 | 6 | 8 | 10 | 8 | 1.5 | 1.8 | 2.0 |
| flow rate | | | | | | | | |
| (ml/min) | | | | | | | | |
| Dope/bore | 1.50 | 1.33 | 1.00 | 0.80 | 1.25 | 1.33 | 1.11 | 1.00 |
| fluid ratio | | | | | | | | |

| External | Water | |
|---|---|---|
| coagulant | | |
| Air gap | 0 | |
| distance (cm) | | |
| Post-treatment | Store in tap water for 3 days, then freeze dry | |
| Spinneret | W/H/ID/L: 11.35/2.05/1.05/5.25 | OD/ID/L: |
| dimension (cm) | | 1.6/1.05/6.5 |

* All the membranes were fabricated under free drawing spinning
* HF means hollow fiber

### Morphology Study

An Olympus stereozoom microscope (SZ-1145) was used as the preliminary tool to observe the microscopic view of the nascent rectangular membrane. The morphology of the resultant membranes was examined by field emission scanning electron microscopy (FESEM, JEOL JSM-6700F) and scanning electron microscopy (SEM, JEOL JSM-5600LV). Samples were prepared in liquid nitrogen followed by platinum coating using a Jeol JEC-1100E Ion Sputtering device.

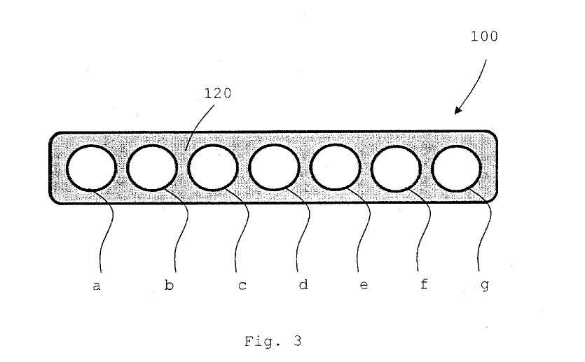

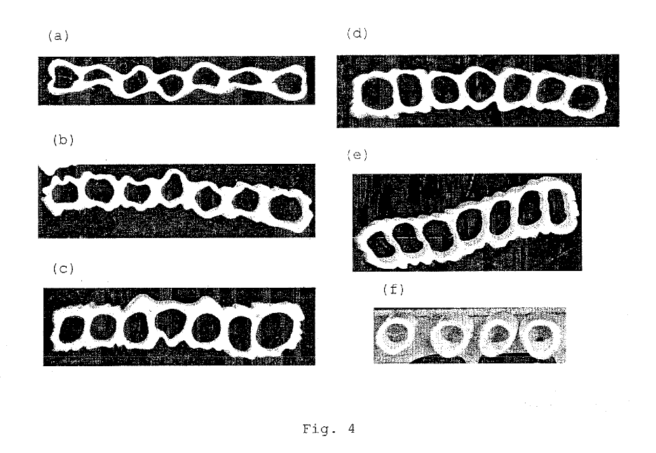

FIG. 4(a) shows a cross-sectional view of a multi-channel rectangular membrane (membrane A of Table 1) obtained with a doped-polymer solution:bore fluid flow ratio of 6:4.

FIG. 4(b) shows a cross-sectional view of a multi-channel rectangular membrane (membrane B of Table 1) obtained with a doped-polymer solution:bore fluid flow ratio of 8:6.

FIG. 4(c) shows a cross-sectional view of a multi-channel rectangular membrane (membrane C of Table 1) obtained with a doped-polymer solution:bore fluid flow ratio of 10:8.

Referring to FIGS. 4 (a) to (c), it is observed that all the multi-channel rectangular membranes A to C show a similar structure consisting of a grooved outer surface and irregular inner multi-channel contours, despite alteration of the spinning parameters, such as the polymer dope and bore flow rates. These rectangular membranes also reveal a symmetric pattern of irregularity, especially for membrane A which is shown in FIG. 4(a). A conventional way of designing wavy patterns on membrane surface is by means of using spinnerets which have corrugated patterns at the outer perimeter of the nozzle holes. On the other hand, the wavy pattern that is observed in FIG. 4(a) is formed spontaneously after extruding from a spinneret as described in the present disclosure.

Due to slow precipitation characteristics of the PVDF doped-polymer solution, the use of a non-solvent induced phase separation provides sufficient time for solidification and promotes the formation of a highly uneven outer layer. For the membranes' outer layer, there is no significant change in morphology except the degree of waviness becomes more profound with an increase in the doped-polymer solution flow rate from 6 to 8 and 10 ml min⁻¹, as illustrated in FIGS. 4 (a) to (c). This may be due to the fact that a higher doped polymer solution flow rate increases the membrane wall thickness and prolongs the phase inversion process, and therefore results in a greater grooved structure from FIG. 4 (a) to (c). As a result, the edges of the multi-channel rectangular membranes show a saw-type or gear-type outer morphology due to enhanced buckling.

FIG. 4(d) shows a cross-sectional view of a multi-channel rectangular membrane (membrane B-1) obtained with a doped-polymer solution:bore fluid flow ratio of 8:8.

FIG. 4(e) shows a cross-sectional view of a multi-channel rectangular membrane (membrane B-2) obtained with a doped-polymer solution:bore fluid flow ratio of 8:10.

FIG. 4(f) shows a cross-sectional view of a hollow fiber membrane (membrane HF-3) obtained with a doped-polymer solution:bore fluid flow ratio of 2:2.

Referring to FIGS. 4 (d) to (e), it can be observed that the deformation of the inner contour increases as the bore fluid flow rate increases. This in turn results in a greater circular lumen shape of the rectangular membranes. As the bore fluid contains 50/50 wt % NMP/Water and NMP is a solvent to PVDF, an increase of bore fluid volume leads to a slight reduction in precipitation rate which in turn prevents the inner shape of the membrane from immediate fixation. As a result, there is sufficient time for the lumen contour to further expand and accommodate the volume strain of the bore fluid.

FIG. 5 shows the proposed mechanisms of grooved outer surface deformation in multichannel rectangular membranes. It is known that the differences in surface tension and density between the external coagulant and the doped-polymer solution may cause the Marangoni instability as shown in FIG. 5(a). After the nascent membrane is immersed in an external coagulant (water) 30, the movement of water molecules 32 may result in perturbation on the membrane surface 34, resulting in wavy surface patterns. Rapid precipitation and solidification may occur at the thin membrane walls (not shown), while demixing takes place at thick membrane walls (not shown). The former induces a slight shrinkage because of rapid solidification, while the latter induces a large shrinkage due to extensive solvent loss. As a result, the demixing and solidification process may lead to the formation of an elastic shell 36 as shown in FIG. 5(b) and creates an inward motion 38 until a next stable stage is reached as illustrated in FIG. 5(c). This implies that the hydrodynamic instability only initiates the inward motion; solidification-induced shrinkage during phase inversion of the outer rectangular perimeter of the membrane coupled with buckling instability are the core factors that magnify and facilitate the final deformation of membranes outer layer with water as a coagulant.

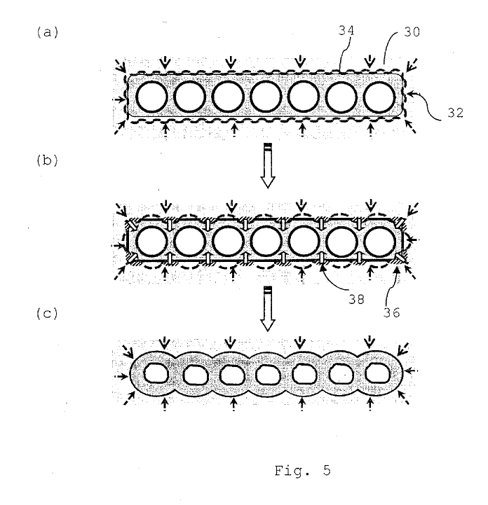

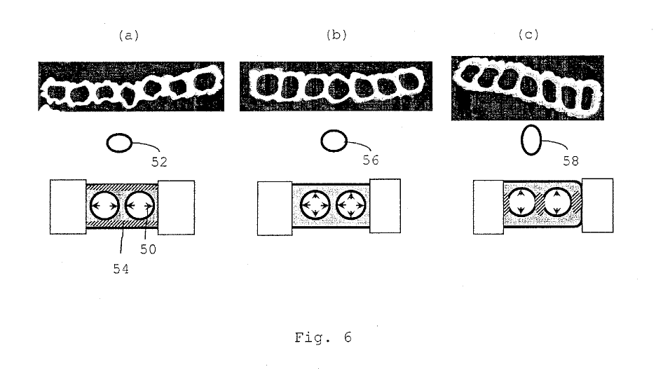

Referring to FIG. 6(a), there is shown a cross-sectional view and the shape of the inner contour of one of the channels of a multi-channel rectangular membrane (membrane B of Table 1) with a bore flow rate of 6 ml min⁻¹, it is shown that the dominant movement of the bore fluid 50 is in the horizontal direction and the resultant shape of the inner contour of the membrane is oval-shaped (in the horizontal direction) 52. The polymer lean phase with a higher solidification rate 54 is also in the horizontal direction.

FIG. 6(b) shows a cross-sectional view and the shape of the inner contour of one of the channels of a multi-channel rectangular membrane (membrane B-1 of Table 1) with a bore flow rate of 8 ml min⁻¹, wherein the inner contour of the membrane has an almost perfect spherical shape 56. This can be attributed to the doped polymer solution/bore fluid ratio of 1 which results in the lumen pressure in the horizontal direction approximately equal to the lumen pressure in the vertical direction. However, the vertical motion becomes dominant when the bore fluid rate is increased to 10 ml min⁻¹ as illustrated in FIG. 6(c). This is plausibly due to the fact that horizontal lumen expansion is restricted by the formation of the membrane walls due to faster solidification rates between the nozzle holes. Thus, the excess bore fluid is forced to move up or down and form a vertically oval lumen contour 58.

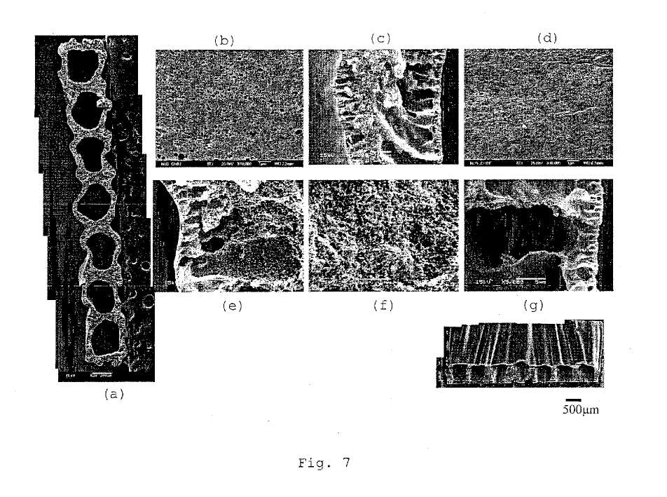

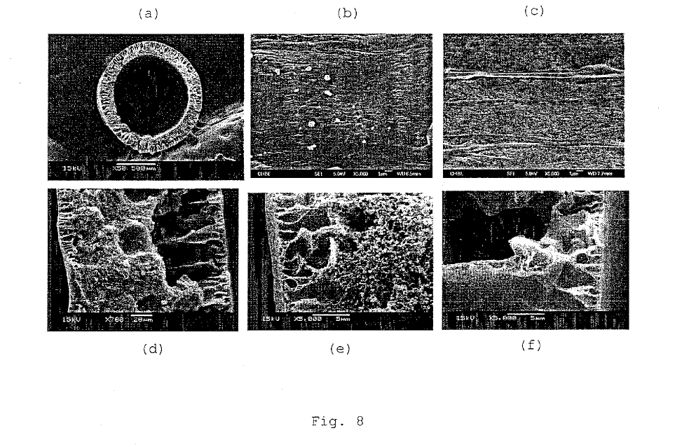

FIG. 7(a) shows a SEM image of the cross-section of the PVDF multi-channel rectangular membrane B of Table 1. FIG. 7(b) shows a SEM image of the outer surface of the membrane of FIG. 7(a) while FIG. 7(d) shows a SEM image of the inner surface of the membrane of FIG. 7(a). From the enlarged images, the asymmetric PVDF membrane consists of three layers, a porous sponge-like middle layer as shown in FIG. 7(f) that is sandwiched between a porous inner layer as shown in FIG. 7(e) and a porous outer selective layer as shown in FIG. 7(g). Both of them are full of finger-like macrovoids. Comparing macrovoid lengths and structure, the intrusion paths for the macrovoid formation in the outer layer are rather profound than those in the inner layer. This implies that the external coagulant (100 wt % water) induces greater convection and diffusion rates than the bore fluid (NMP/water:50/50 wt %).

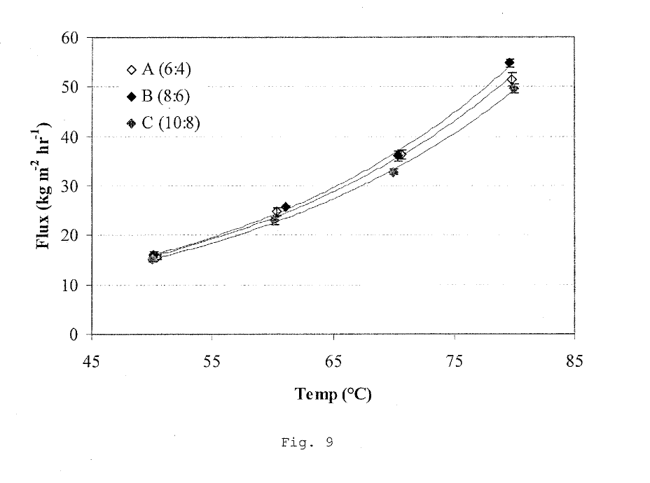

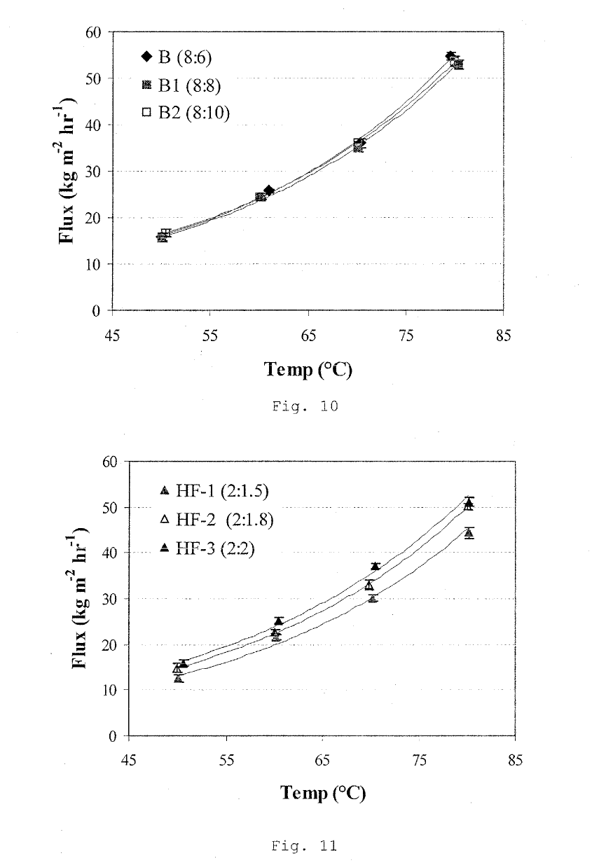

The aforementioned morphology can also be reproduced in the hollow fiber membrane HF-3 of Table 1. FIG. 8(a) shows a SEM image of the cross-section of the PVDF hollow fiber membrane while FIG. 8(b) shows a SEM image of the outer surface of the membrane of FIG. 8(a). FIG. 8(c) shows a SEM image of the inner surface of the membrane of FIG. 8(a) and FIG. 8(d) shows a SEM image of an enlarged cross sectional view of the membrane of FIG. 8(a). FIG. 6(e) shows a SEM image of an enlarged view of the inner surface of FIG. 8(d). FIG. 8(f) shows a SEM image of an enlarged view of the outer surface of FIG. 8(b).

### Membrane Characterization

The mechanical properties of as-spun fibers were conducted by an Instron tensionmeter (Model 5542, Instron Corp.). The fiber sample was clamped at both ends and pulled in tension at a constant elongation of 10 mm min⁻¹ with an initial gauge length of 25 mm. Tensile stresses at break, tensile strain and Young's modulus were obtained from the stress-strain curves. At least three readings were recorded and an average of the readings was obtained from the results.

The overall porosity of the hollow fiber membrane (s) was estimated by the ratio of empty voids to the total volume of the membrane sample. The hollow fiber membrane sample was first weighed with a beam balance, followed by immersing it in a 33% LIX54 kerosene solution for ten days. An assumption was made in which all the empty voids were filled with the liquid kerosene solution. Then the fully impregnated fiber was removed from the kerosene and any excess kerosene in the lumen-side and on the outer surface was wiped away.

Table 2 below summarizes characteristics of the multichannel rectangular membrane and hollow fiber membrane. All membranes have moderately high porosity (89-91%). Since multi-channel rectangular membranes have larger dimensions with much rigid and complicated structure, they have lower elasticity (strain at break), tensile strength and modulus than those of hollow fiber membranes. However, compared with hollow fiber membranes, rectangular membranes can withstand the highest load before break, which enable rectangular membranes to survive in high-load separation or back wash.

When the bore fluid flow rate increases from 1.5 to 1.8 and to 2 ml min⁻¹, the overall membrane thickness is reduced dramatically from 220 to 180 and 150 μm, respectively, as listed in Table 2.

TABLE 2
Characteristic properties of multi-channel
rectangular and hollow fiber membranes.

| Membrane ID | A | B | B-1 | B-2 | C | HF-1 | HF-2 | HF-3 |
|---|---|---|---|---|---|---|---|---|
| Dope:bore flowrate | 6:4 | 8:6 | 8:8 | 8:10 | 10:8 | 2:1.5 | 2:1.8 | 2:2 |
| (ml/min) | | | | | | | | |
| Dope:bore flows ratio | 1.50 | 1.33 | 1.00 | 0.80 | 1.25 | 1.33 | 1.11 | 1.00 |
| Thickness (μm) | — | — | — | — | — | 220 | 180 | 150 |
| Porosity (%) | 89.2 ± 1.3 | 90.9 ± 0.5 | 90.7 ± 0.3 | 90.7 ± 1.5 | 89.4 ± 1.6 | 89.9 ± 0.7 | 90.3 ± 0.1 | 90.7 ± 0.4 |
| Strain at break (%) | 97 ± 5 | 118 ± 10 | 113 ± 16 | 121 ± 12 | 146 ± 12 | 130 ± 16 | 126± | 143 ± 4 |
| Tensile stress at break: | 0.39 ± 0.05 | 0.42 ± 0.10 | 0.59 ± 0.06 | 0.52 ± 0.04 | 0.43 ± 0.15 | 0.72 ± 0.06 | 0.90 ± 0.04 | 0.93 ± 0.03 |
| (MPa) | | | | | | | | |
| Young's Modulus | 13.1 ± 1.9 | 13.7 ± 1.4 | 13.6 ± 2.1 | 12.6 ± 2.9 | 13.6 ± 3.9 | 15.6 ± 1.6 | 16.9± | 19.7 ± 2.5 |
| (MPa) | | | | | | | | |
| Maximum load at | 2.23 ± 0.26 | 2.27 ± 0.24 | 2.59 ± 0.21 | 2.87 ± 0.23 | 2.52 ± 0.29 | 0.54 ± 0.03 | 0.56 ± 0.05 | 0.52 ± 0.01 |
| break (N) | | | | | | | | |
| DCMD performance at | 51.79 | 54.73 | 52.99 | 53.57 | 49.63 | 44.33 | 50.05 | 51.12 |
| 80° C. (kg/m² hr) | | | | | | | | |

### Example 3

### Membrane Distillation

Water flux is determined by a laboratory scale DCMD unit. The MD modules are fabricated and tested in model seawater (i.e., 3.5 wt % NaCl in water). The feed solution is circulated through the shell side of modules and pure-cold water is pumped through the lumen side of the fibers. The inlet temperature at the lumen side of the permeate is kept constant at 17.5±0.5° C. throughout the entire experiment, while the feed temperature is varied between 50 to 80±0.5° C. In addition, the flow velocities of the feed and permeate are kept constant at 1.1±0.03 ms⁻¹ and 1.1±0.03 ms⁻¹, respectively.

The NaCl concentration of the feed solution and ionic conductivity of the permeate stream were determined by a conductivity meter, Lab 960 from Schott Instruments. The separation factor (β) and vapor permeation flux, Jv (kg/m² h) were determined using the equations below:

$$\begin{matrix}{J}_{v} = \frac{{M}_{w}}{nAt} & ( 1 ) \\ {A}_{hf} = π {d}_{o} L & ( 2 ) \\ {A}_{hr} = WHL & ( 3 )\end{matrix}$$

where Cₚ and C_{f} are the NaCl concentrations in the bulk permeate and feed solutions, respectively, M_{w} (kg) represents the weight of the collected permeate, n refers to the number of hollow fibers, A_{hf} and Aₕᵣ (m²) are the effective membrane area of hollow fibers and hollow rectangular fibers, t (h) represents the time interval, dₒ (m) corresponds to the outer diameter of hollow fibers, L (m) indicates the effective length of membranes, W (m) is the width of membranes, and H (m) refers to the height of membranes. All permeate fluxes obtained are calculated using the outer selective perimeter of the membranes.

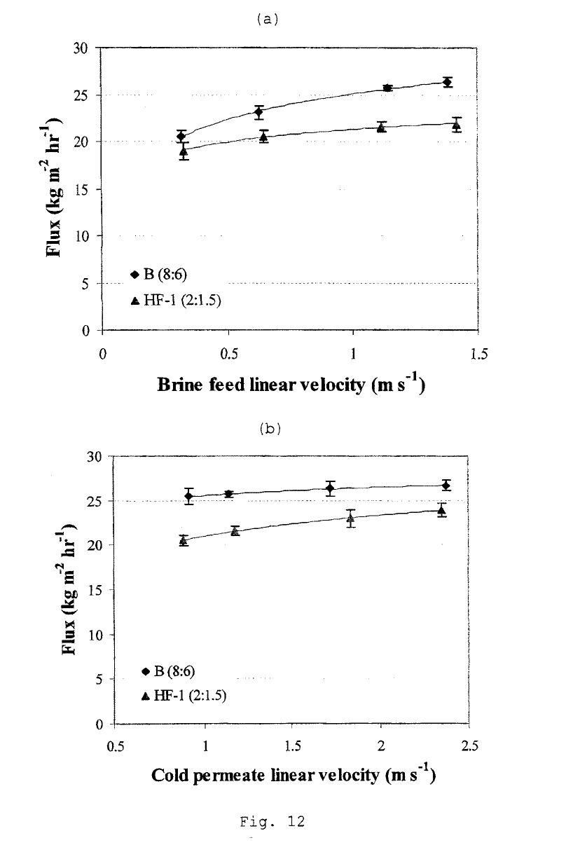

FIG. 9 shows the distillate flux of multi-channel rectangular PVDF membranes spun with different doped polymer solution and bore fluid rates as a function of feed temperature. By attuning the ratio of doped polymer solution flow rate to bore fluid flow rate, membrane B of Table 1 with a ratio of 8:6 and a bore fluid flow rate of ml min⁻¹, shows the highest permeate flux among the rectangular membranes. Membrane B with a higher wavy outer selective layer achieves a flux enhancement about 5% than membrane A of Table 1 with a ratio of 6:4 and a bore fluid flow rate of 4 ml min⁻¹. The enhancement may be attributed to a turbulence flow induced by a greater degree of wavy geometry for membrane B, which ultimately results in a higher water vapor convection rate from the hot feed saline solution.

On the other hand, membrane C with the highest doped polymer solution and bore fluid flow rate of 10 ml min⁻¹ and 8 ml min⁻¹ exhibited a reduction of about 9% in the distillate flux. This may be due to the membrane having a greater molecular orientation induced by shear stress that is fixated immediately during wet spinning. This may also be due to a higher mass transfer resistance induced by a thicker membrane wall.

### Example 4

### Effect of Bore Fluid Rate

The PVDF doped polymer solution flow rate of 8 ml min⁻¹ was adopted for further investigation on the effect of bore fluid flow rate on flux performance. The DCMD performance of PVDF multi-channel rectangular membranes with different bore fluid flow rates is illustrated in FIG. 10. Membrane B with a bore fluid flow rate of 6 ml min⁻¹, Membrane B-1 with a bore fluid flow rate of 8 ml min⁻¹ and Membrane B-2 with a bore fluid flow rate of 10 ml min⁻¹ are employed in this investigation.

Conventional hollow fiber membranes were spun using a similar doped polymer solution/bore fluid ratio for comparison in FIG. 11. FIG. 11 summarizes the desalination performance of the hollow fiber membranes and shows that the distillate flux increases (i.e., 12.9% and 15.3% increment for membranes B-1 and B-2, respectively) with an increase in bore fluid flow rate. Membrane HF-1 with a bore fluid flow rate of 1.5 ml min⁻¹, Membrane HF-2 with a bore fluid flow rate of 1.8 ml min⁻¹ and Membrane HF-3 with a bore fluid flow rate of 2 ml min⁻¹ are employed. On the other hand, it can be observed from FIG. 10 that the effect of increasing bore flow rate on Direct Contact Membrane Distillation (DCMD) performance is not significant for multi-channel rectangular membranes as an increase in bore fluid rate only reduces the wall thickness among multiple bore fluid channels, but does not directly reduce the outer layer thickness of the membrane.

### Example 5

### Effect of Feed and Permeate Flow Rates

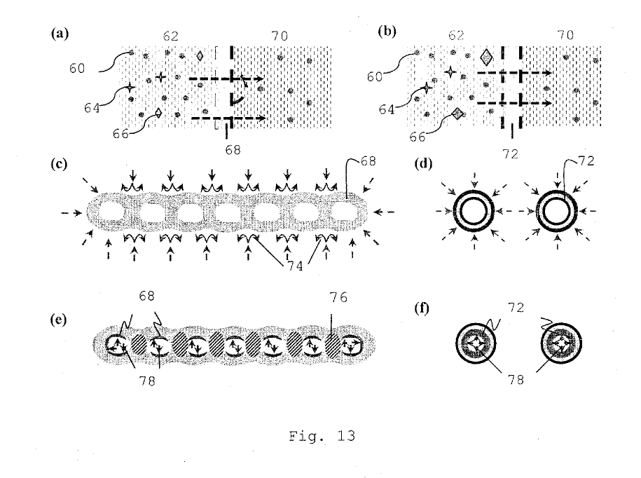

FIG. 12 (a) shows the effect of brine feed linear velocity on flux across the multi-channel rectangular membrane B, while FIG. 12 (b) shows the effect of lumen linear velocity on flux. The performance data of hollow fiber membrane HF-1 is included in FIG. 12 (a) and FIG. 12 (b) for comparison. It can be observed that multi-channel rectangular membranes show a higher increase in flux with increasing feed linear velocity than that of hollow fiber membrane.

It can be seen in FIG. 12 (b) that the multi-channel rectangular membrane has a converse DCMD result in lumen linear velocity. The surface area for effective condensation or vapor transport of rectangular membranes was estimated based on the following assumptions: (1) two lumen holes at the membrane's edge have ˜75% condensation capability, (2) the middle five contours are presume to be ˜50%, and (3) the blind spot at the membrane region between each inner contour is not involved in the diffusion path. The calculated total condensation area is reduced by approximately 42% as compared to seven single hollow fibers. Therefore, the performance of rectangular membranes with a lower condensation area may reach a plateau relatively fast and may have a smaller flux improvement by increasing the lumen linear velocity. In view of membrane configuration, the multi-channel rectangular membrane with grooved outer surface is a desirable candidate for promoting turbulent flow and has a greater performance than hollow fiber membrane when the brine linear velocity is increased in the shell side.

The proposed transport mechanisms of water vapor across the membrane matrix for both hollow rectangular membrane and hollow fiber membrane are illustrated in FIGS. 13 (a) and (b) respectively.

Referring to FIG. 13(a), water molecules 60 in the hot saline solution 62 comprising of Na ions 64 and Cl ions 66 pass through a hydrophobic multi-channel rectangular membrane 68 into a cold permeate region 70. Similarly, referring to FIG. 13 (b), water molecules 60 in the hot saline solution 62 pass through the hollow fiber membrane 72 into a cold permeate region 70. FIG. 13(c) illustrates the turbulent flow 74 on the grooved outer surface of the multi-channel rectangular membrane 68. Due to the membrane configuration, multi-channel rectangular membrane with grooved outer surface induces turbulent flow, which results in a higher water vapor convection rate from the hot saline solution. On the other hand, the hollow fiber membranes do not exhibit turbulent flow on the outer surface of the membranes 72 as shown in FIG. 13(d). FIGS. 13(e) and (f) shows the movement of the condensed water vapour 78 on the inner surface of the multi-channel rectangular membrane 68 and the hollow fiber membrane 72 respectively. It can be noted, despite turbulent flow on the outer surface of the rectangular membrane, that there are regions 76 in the rectangular membranes that are not involved in the diffusion path of the water molecules as seen in the cross-sectional view of the membrane in FIG. 13(e).

This confirms that the rectangular membranes possess a lower surface area and effective evaporation path than the hollow fiber membrane because hollow fiber membrane are individually separated and spread out in a membrane module. Taking into account effective surface contact, the rectangular membranes adopt the measurement of flat sheet membrane and consequently reveal a lower surface area and effective evaporation path than hollow fiber membranes. The flux enhancement in rectangular membranes is attributed to the provocation of turbulences and formation of eddies, leading to an increase in momentum convection at the grooved outer surface of the hot feed brine. In addition, this phenomenon also may enhance fluid mixing on the surface and possibly reduce temperature and concentration polarizations. Apart from the enhancement in fluid mechanics, the grooved geometry on the outer surface of the rectangular membrane can serve as a sieve spacer efficiently separating the membrane, and reduces the possibility of the membrane from forming clusters.

### APPLICATIONS

The disclosed membrane and the process of making the same may be used in various applications including, membrane separation treatment of fluids such as the desalination of seawater, desalination of brine, purification of wastewater, production of sterile water, food processing acid concentration, biomedical application, removal of volatile organic compounds (VOCs), and oxygen isotopic water separation.

The disclosed membrane has characteristics of (1) greater mechanical durability, (2) easy handling and assembly; (3) acting as spacers to separate membranes from attaching together; and (4) creating eddies flow at the membrane outer selective layer.

The disclosed rectangular membranes with multi-channel take the strengths from both flat sheet and hollow fiber membranes, and have characteristics of greater mechanical durability, lower permeate pressure drop, high surface area and easy assembly.

Advantageously, the disclosed membranes such as microporous PVDF multi-channel rectangular membranes may be used for direct contact membrane distillation of seawater. In addition to having better mechanical strength and ease of assembly, the wavy contour of the rectangular membranes may induce eddies flows and improve mass transfer and energy efficacy.

The disclosed membranes provide the hybrid and combined advantages offered by hollow fiber (i.e. high membrane area per volume ratio and ease of assembly into membrane modules) and flat sheet membranes (i.e. greater mechanical durability and compressibility). Advantageously, the membrane made according to the disclosed process may be able to utilise waste energy sources, low-cost solar and geothermal energy, thus lowering the cost of production. The disclosed process further provides the advantages of salt crystallization and can be used for high salinity water separation. Due to the outer selective layer, the disclosed multi-channel rectangular membranes may promote the turbulent flow and formation of eddies to improve flux across the membrane. The disclosed membrane may also be used as spacers to separate membranes and prevent them from attaching to one another.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A membrane comprising a porous polymer body with a plurality of channels extending through said polymer body.

2. The membrane as claimed in claim 1, wherein the longitudinal axis of each channel is parallel to the longitudinal axis of an adjacent channel.

3. The membrane as claimed in claim 1 or 2, wherein each channel has an inlet at one end and an outlet at an opposite end to said inlet.

4. The membrane as claimed in any one of the preceding claims, wherein the external surface of the membrane is uneven.

5. The membrane as claimed in claim 4, wherein the uneven external surface of the membrane comprises plural groove formations.

6. The membrane as claimed in claim 5, wherein each of the groove formations are formed on the exterior surface of the membrane.

7. The membrane as claimed in any one of claims 1 to 6, wherein the body is in the form of a membrane sheet.

8. The membrane as claimed in any one of the preceding claims, wherein the plurality of channels has a cross-sectional shape selected from the group consisting of circular-shaped, spherical-shaped, and oval-shaped.

9. The membrane as claimed in any one of the preceding claims, wherein the polymer body is hydrophobic.

10. The membrane as claimed in claim 9, wherein the hydrophobic polymer body comprises a polymer selected from the group consisting of poly alkylacrylate, polydiene, polyolefin, polylactone, polysiloxane, polyoxirane, polypyridine, polycarbonate, poly vinyl acetate, polysulfone, polypropylene (PP), polytetrafluoroethylene (PTFE), polyethylene (PE), polyvinylidenefluoride (PVDF), polymethylpentene (PMP), polydimethylsiloxane, polybutadiene, polystyrene, polymethylmethacrylate, perfluoropolymer, poly (2-alkyl or phenyl oxazolines), polyetheretherketone (PEEK), polyphenylene sulfide (PPS), liquid crystal polymers (LCPs), polyimides and copolymers thereof.

11. The membrane as claimed in any one of the preceding claims, wherein the pore size is in a range from about 10 nm to about 1000 nm.

12. The membrane as claimed in any one of the preceding claims, wherein the diameter or equivalent diameter of the channel is in the millimeter or micrometer range.

13. The membrane as claimed in claim 12, wherein the diameter or equivalent diameter of the channel is from about 450 μm to about 1500 μm.

14. The membrane as claimed in any one of the preceding claims, wherein said membrane has from 2 to 50 channels.

15. The membrane as claimed in any one of the preceding claims, wherein the wall thickness between adjacent channels is in the micrometer size range.

16. The membrane as claimed in any one of the preceding claims, wherein the longitudinal axes of the channels are arranged in a single plane that extends through the membrane.

17. A fluid treatment system comprising:
a. a porous membrane body comprising an exterior surface and a plurality of channels extending through said body, opposite said exterior surface; and b. a feed fluid having one or more impurities contained therein and being passed through at least one of (i) the exterior surface of said porous membrane body or (ii) the walls of said plurality of channels, wherein after passage through either said exterior surface or said walls of said channels, a permeate fluid is formed on the opposite side from which the feed fluid passed, said permeate stream having less impurities relative to said feed water.

18. A method of making a membrane comprising the step of forming a plurality of channels in a porous polymer body.

19. A method as claimed in claim 18, wherein said forming step comprises extruding a polymer solution into a coagulant bath.

20. A method as claimed in claim 19, wherein during said extruding step, the polymer solution is extruded into the coagulant bath concurrently with one or more bore fluid streams passing therebetween said polymer solution to thereby form said porous membrane body.

21. The method as claimed in claim 20, wherein prior to said extruding step, said polymer solution is mixed with one or more hydrophobic additive compounds.

22. The method as claimed in claim 21, wherein prior to said extruding step, said polymer solution is mixed with at least one solvent compound.

23. The method as claimed in claim 22, wherein prior to said extruding step, said polymer solution is mixed with at least one non-solvent compound to form a doped-polymer solution.

24. The method as claimed in any one of claims 18 to 23, wherein said polymer solution comprises at least one polymer selected from the group consisting of: poly alkylacrylate, polydiene, polyolefin, polylactone, polysiloxane, polyoxirane, polypyridine, polycarbonate, poly vinyl acetate, polysulfone, polypropylene (PP), polytetrafluoroethylene (PTFE), polyethylene (PE), polyvinylidenefluoride (PVDF) polymethylpentene (PMP) polydimethylsiloxane, polybutadiene, polystyrene, polymethylmethacrylate, perfluoropolymer, poly (2-alkyl or phenyl oxazolines), polyetheretherketone (PEEK), polyphenylene sulfide (PPS), liquid crystal polymers (LCPs), polyimides and copolymers thereof.

25. The method as claimed in claim 22, wherein the solvent compound is selected from the group consisting of: N-methyl-2-pyrrolidinone, dimethylacetamide, dimethylformamide triethelyne phosphate, acetone, tetrehydrofuran, dioxane, ethyl acetate, propylene carbonate, methyl ethyl ketone, dimethyl sulfoxide, cyclohexane, methyl isobutyl ketone and dimethyl phthalate.

26. The method as claimed in claim 23, wherein the non-solvent compound is selected from the group comprising methanol, ethanol, propanol, butanol, diethylene glycol, ethylene glycol, glycerol, polyethylene glycol, polyvinylpyrrolidone and mixtures thereof.

27. The method as claimed in any one of claims 20 to 26, wherein the one or more bore fluid streams comprise a solvent and water.

28. The method as claimed in claim 27, wherein the ratio between the flow rate of said polymer solution to said bore fluid stream is in range of about 0.8 to 2.

29. The method as claimed in any one of claims 18 to 28, wherein the porous membrane body is post-treated in a water bath.

30. The method according to claim 29, wherein after said post-treatment in the water bath, said porous membrane body is dried in a freezer.

31. The method as claimed in any one of claims 18 to 30, wherein the one or more bore fluid streams are arranged adjacent relative to one another and having a separation of about 0.5 mm between each stream.

32. The method as claimed in any one of claims 18 to 31, wherein the coagulant bath is water.

33. A spinneret, for forming a polymer membrane comprising:
a chamber for containing a polymer solution therein and having an inlet for receiving said polymer solution;
a polymer ejection nozzle in fluid communication with the chamber; and
a series of bore fluid ejection nozzles for containing a bore fluid therein, the coagulant ejection nozzles being disposed within the annulus of the polymer ejection nozzle such that when said polymer solution is ejected from the polymer ejection nozzle into a coagulant bath, the bore fluid is concurrently ejected from the bore fluid ejection nozzles to form a plurality of channels that extend through a porous polymer body.
